(19) United States
(12) Patent Application Publication
(10) Pub. No.: US 2005/0022900 A1
(43) Pub. Date: Feb. 3, 2005

(54) Locking device for a plane machine

(76) Inventor: Bor Yann Chuang, Taichung (TW)

Correspondence Address: TROXELL LAW OFFICE PLLC, SUITE 1404, 5205 LEESBURG PIKE, FALLS CHURCH, VA, 22041, US

(21) Appl. No.: 10/629,791

(22) Filed: Jul. 30, 2003

(51) Int. Cl. B27C 1/00

(52) U.S. Cl. 144/117.1

(57) ABSTRACT

A locking device for a plane machine includes a handle, an actuating rod, two side bases, an urging block respectively provided at two sides of each side base. The actuating rod is urged by a spring to bias a bit to one side of a machine base of a plane machine when the locking device is in a normal not-locking positions with the handle being in a not-pushed position, and the machine base is not locked with four posts of the plane machine. When the handle is pressed inward to a locking position, the actuating rod is moved to force the two side bases move nearer the center of the machine base, forcing the four urging blocks to tightly pushing the four posts to lock the machine base at an adjusted position after the machine base is adjusted to a needed height by means of a rotating button and a threaded rod.

### BACKGROUND OF THE INVENTION

1. Field of the Invention

This invention relates to a locking device for a plane machine, particularly to one locking a machine base with four posts of a plane machine.

2. Description of Prior Art

A conventional plane machine generally has a machine base moving up and down along posts, and in order to reinforce stability of the machine base, some plane machines have a locking device for locking the machine base with the posts after adjusted in its height, as disclosed in a U.S. Pat. of No. 5,771,949 shown in FIGS. 1 and 2. It includes posts 1, a handle 2 provided between two posts 2. When the handle 2 is pressed down, a locking rod 3 and a length-changing rod 4 respectively positioned at the front and at the rear of the machine base are pressed down. The length-changing rod 4 consists of a first connect rod 5 and a second connect rod 6 inserted in a connect groove 7 of the first connect rod 5. The first connect rod 5 has a center slot 8 for receiving a spring 9, forcing the second connect rod 6 to be indirectly pushed by the spring 9. So when the handle 2 is pressed down, the locking rod 3 may force the second connect rod 6 move backward to compel the clamp firmly clamp the post 1.

However, the conventional plane machine has too many components to form a very complicated structure, demanding comparatively high precision, taking much time in assembling, difficult to obtain expected effect.

### SUMMARY OF THE INVENTION

This invention has been devised to offer a locking device for a plane machine, which includes a handle to move an actuating rod to move lengthwise in line on a machine base, then moving inward two side bases limitedly positioned at two sides of the machine base. Then an urging block respectively fixed at two sides of each side base clamp tightly each of four posts so that the machine base may be firmly locked with the posts, after adjusted in its height.

### BRIEF DESCRIPTION OF DRAWINGS

This invention will be better understood by referring to the accompanying drawings, wherein:

FIG. 1 is an exploded perspective view of a locking device of a conventional plane machine;

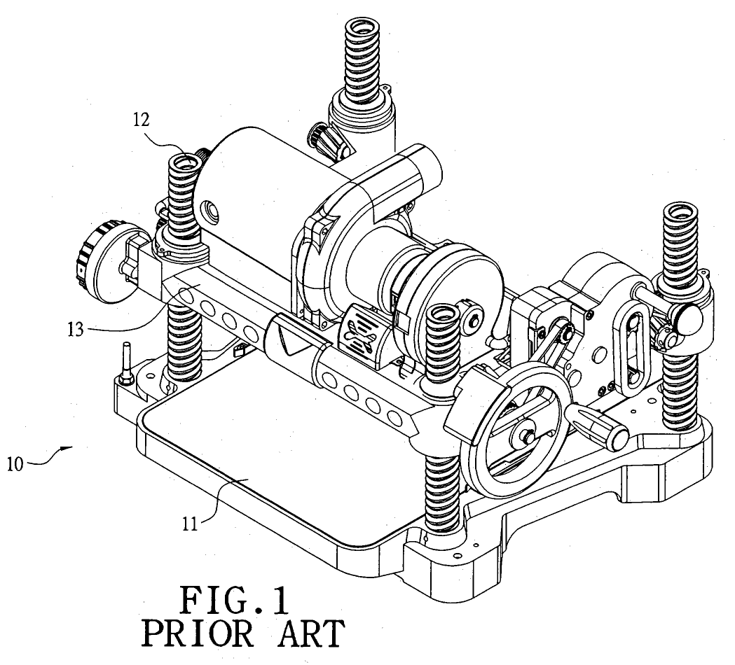

FIG. 2 is a perspective view of the locking device of a conventional plane machine;

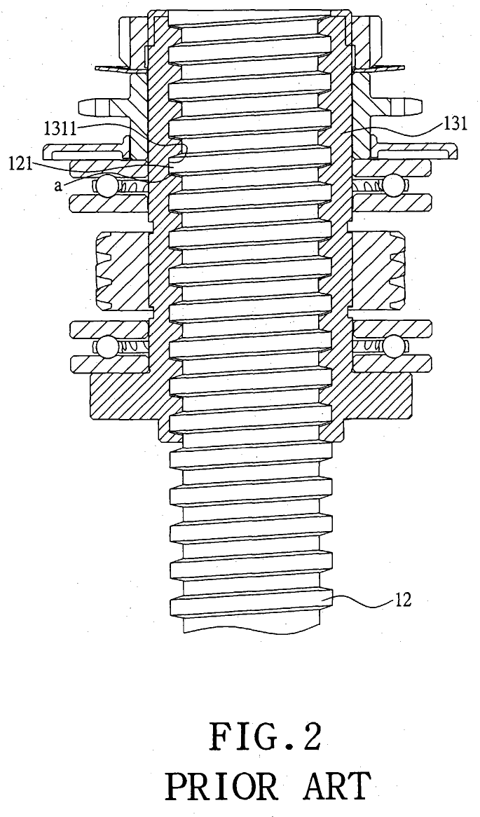

FIG. 3 is a perspective view of a plane machine having a locking device in the present invention;

FIG. 4 is a partial perspective view of the plane machine with the locking device in the present invention;

FIG. 5 is a partial exploded perspective view of the locking device in the present invention;

FIG. 6 is a partial enlarged perspective view of the locking device in the present invention;

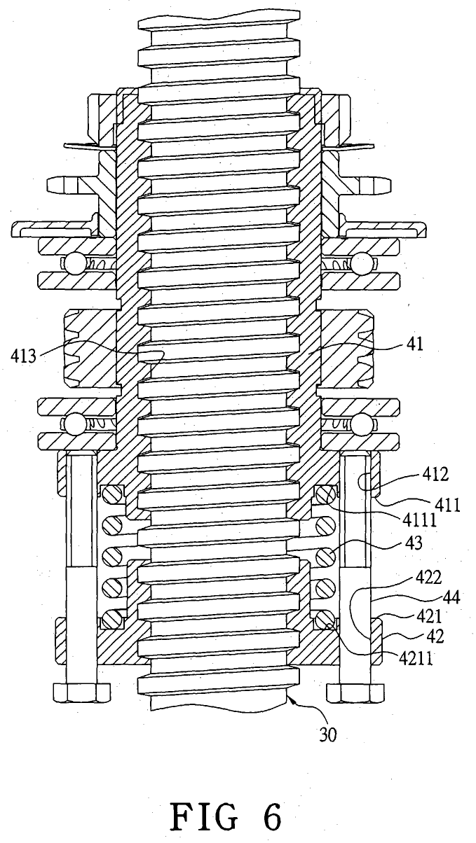

FIG. 7 is an upper view of the locking device in a loose condition in the present invention; and,

FIG. 8 is an upper view of the locking device in a tightly locked condition in the present invention.

### DETAILED DESCRIPTION OF THE PREFERRED EMBODIMENT

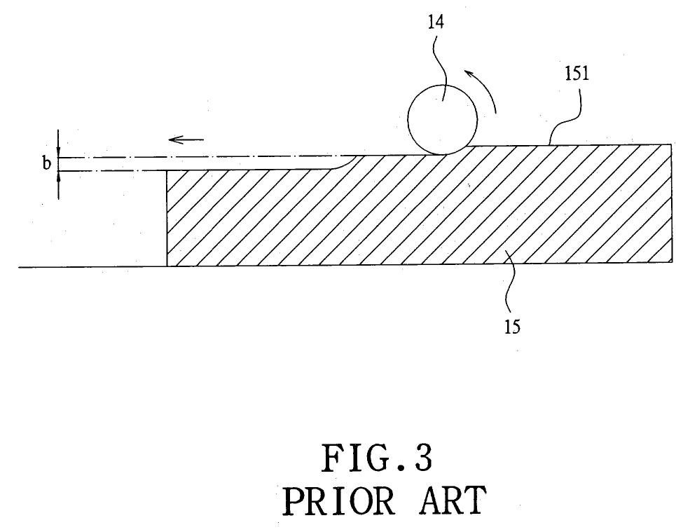

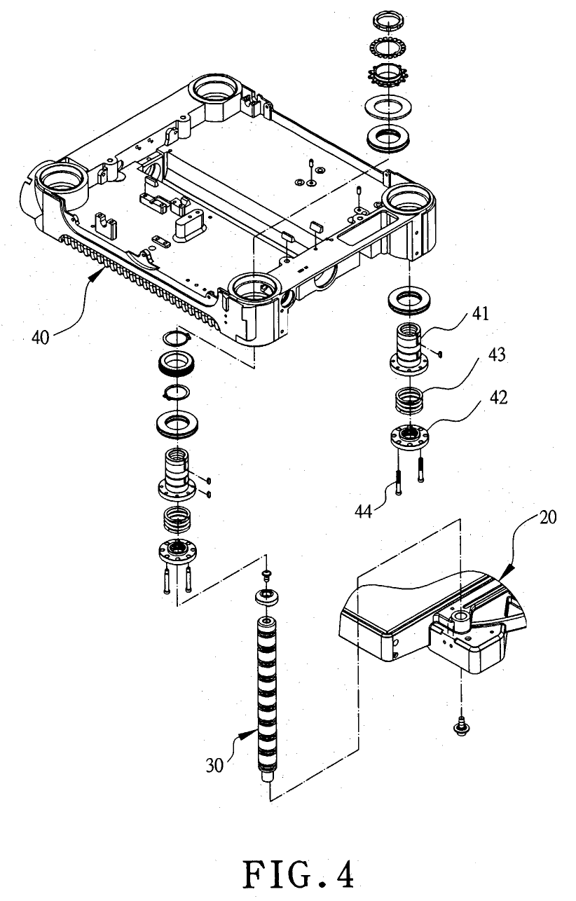

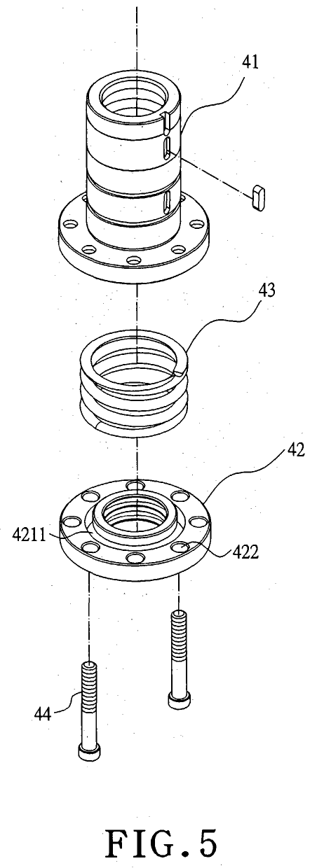

A preferred embodiment of a locking device for a plane machine in the present invention, as shown in FIGS. 3, 4 and 5 is combined with a plane machine, which includes a bottom base 20, four posts positioned respectively at four corners of the bottom base 20, a machine base 30 connected with the four posts 21 by means of a ring 31, a moving rod 22 threadably connected with the center portion of two sides of the machine base 30, a rotating button 23 to control a threaded rod 22 in upright movement. Those components are the same as the convention art, not to be described. The important improvement of the invention is the components described below.

A locking device to be provided on the machine base 30 includes two rod bases 40, an actuating rod 50, a handle 60, and two side bases 70.

The two rod bases 40 are respectively fixed on the upper surface of two sides of the machine base 20, having a shaft hole 41 for the actuating rod 50.

The actuating rod 50 has two ends respectively fitting in the shaft holes 41 of the two rod bases 40, an insert rod 51 fixed upright on the left end, and a spring 52 fitting around the right end.

The handle 60 is L-shaped, having a shaft hole 61 in one end for a pivotal shaft 62 to fit therein and also to extend pivotally in an upper surface of the left side of the machine base 30, a rectangular groove 63 formed in an outer end near the shaft hole 61 for the insert rod 51 to fit therein. Then the handle 60 can move the actuating rod 50 lengthwise when it is pushed inward from a normal position to a locking position.

The two side bases 70 are shaped as an elongate plate, respectively positioned on the upper surface of the two sides of the machine base 30, having a limit slot 71 respectively yin two sides for a limit screw 72 to screw with and also with the machine base 30. Each side base 70 further has an urging block 73 respectively at two sides, and each urging block 73 has a vertical urging surface 731, with the distance between two of the urging surfaces 731 being a little larger than the distance between the two posts 21. Further, each side base 70 has a pair of pivotal studs 74 to pivotally connect with the two ends of the actuating rod 50, and at the same time the two ends of the spring 52 held at the right end of the actuating rod 50 between the outer edge of the rod base 40 and the pivotal stud 74. Then the rod base 40 is a bit biased to the right side of the machine base 30 by the elasticity of the spring 52 when the locking device in the normal condition, with the handle 60 being in not pressed inward. That is, the machine base is not locked with the posts 21. But when the machine base is wanted to be locked with the posts 21 after adjusted in its height, the handle 60 is pushed inward moving the actuating rod to force the two side bases 70 move nearer to the center of the machine base 30 resisting the elasticity of the spring 52, and subsequently the urging surface of the four urging blocks 73 compress respectively the inner wall of the four posts 21, in case the handle 60 is pressed inward to a locking position. Thus the machine base 50 is locked with the four posts 21.

Next, the two urging blocks 73 positioned on each side base 70 may be made with one being stationary and the other being rotatable pivotally. The stationary urging block is then locked with the outer wall of a plate 75 extending up from one side of each side base 70 by means of a screw 76. And the rotatable urging block is pivotally connected with the other side of each side base 70 by means of a pivot 77. Further, a stud 78 is provided upward at the other side of the side base 70, and a screw 79 with a buffer spring 791 is fitted around pivotally connected with the stud 78 so the buffer spring 791 compresses the urging block 73 to move farther away from one end of the pivotal point. Then the urging block 73 may extend downward to rest on a stop 732 at the side edge of the side base 70. Thus when the urging block 73 is compressed by the buffer spring 791, the urging block 73 is prevented from rotating outward by the stop 732. When the urging block 73 presses tightly each post 21, the buffer spring 791 may buffer the pressure. Further, in order to facilitate the urging block 73 to press smoothly each posts 21, the urging block 73 has its front portion of the outer wall shaped with a proper slope to contact each post 21 so as to let each post 21 gradually contact with the urging surface 731 of the urging block 73.

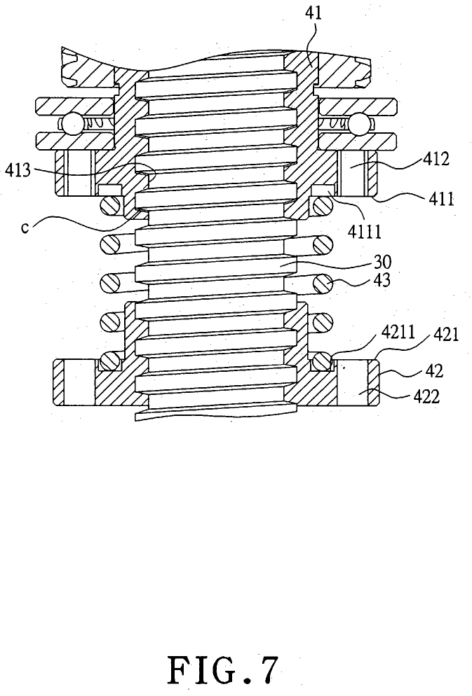

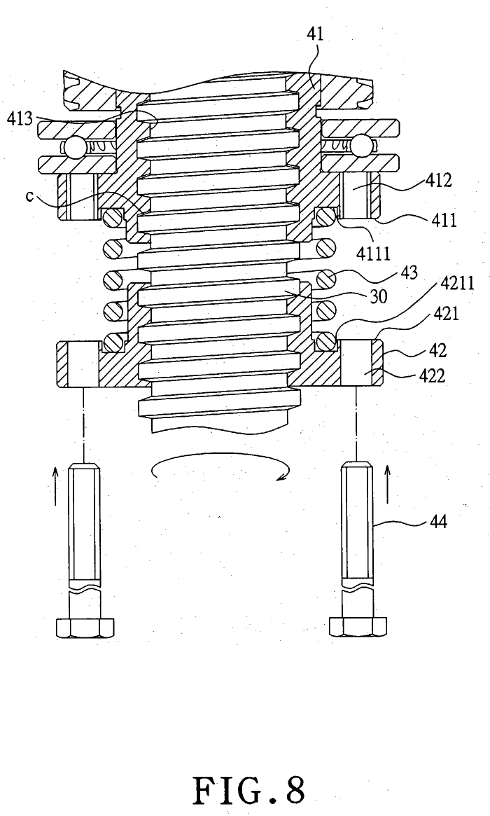

Next, as shown in FIGS. 7 and 8, the function of the locking device is to be described. When the machine base 30 is not yet locked in the normal position, the handle 60 of the locking device is in a loose not-locking position, with the right one of the two side bases 70 actuated by the actuating rod 50 urged by the elasticity of the spring 52 to bias to the machine base 30. And the two urging blocks 73 of the right side base 70 are positioned at an outer side of two posts 21, and the two urging blocks 73 on the left side base 70 are positioned at an inner side of the other two posts 21, in the separated condition without contacting with one another.

If the machine base 30 is wanted to be locked after adjusted in its position, the handle 60 is pushed inward to a locking position, letting the insert rod 51 move the actuating rod 50 and then the two side bases 70 nearer to the center of the machine base 30, with the two pairs of the urging blocks 73 respectively pressing from the outside and from the inside to the posts 21 so as to lock the machine base 30 with the four posts 21.

On the contrary, if the machine base 30 is wanted to be released from the posts 21, repeating reversely the locking process can attain the purpose, with the spring 52 combined at the right end of the actuating rod 50 recovers its elasticity to push back the side bases 78 to its biased position. So the locking device is easy to operate.

While the preferred embodiment of the invention has been described above, it will be recognized and understood that various modifications may be made therein and the appended claims are intended to cover all such modifications that may fall within the spirit and scope of the invention.

1. A locking device for a plane machine, said plane machine comprising a bottom base, four posts positioned at four corners of said bottom base, a machine base combined with said four posts at four corners by means of four rings, a threaded rod engaged with a center portion of one lateral side of said machine base, a rotating button fixed with an upper end of said moving rod for rotating said moving rod so as to move up and down said machine base, and a locking device combined on said machine base, said locking device comprising:
Two rod bases respectivey fixed on an upper surface of two sides—the left and the right side—of said machine base and having a shaft hole:
An actuating rod having two ends respectively fitting in said shaft hole of each said rod base, possible to move lengthwise in line, a left end of said actuating rod having an insert rod extending upward:
A handle of an L shape having an inner end pivotally connected with an upper surface of a left side of said machine base, having a rectangular hole in the inner end for said insert rod of said actuating rod to fit therein pivotally, said handle possible to be pushed inward to a locking position to force said actuating rod to move lengthwise in line for a preset distance:
Two side bases respectively positioned limitedly on an upper surface of the two sides of said machine base, possible to move limitedly in the same direction as said actuating rod, having an urging block respectively at two sides, each said urging block provided with an urging surface in an outer side, said side bases respectively further having, its intermediate portion pivotally connected with two ends of said actuating rod:
Said two side bases urged by said spring to bias a bit to the right side of said machine base when said locking device is in a normal not-locking condition, said handle pushed inward to force said actuating rod to move said two side bases nearer the center of said machine base when said machine base is wanted to be locked against said posts, said urging blocks of said two side bases accordingly pressed to move to push against the inner wall of each said post so as to lock said machine base with said posts.

2. The locking device for a plane machine as claimed in claim 1, wherein said actuating rod has its right end fitted around with a spring, and said spring has two ends respectively limitedly located between an outer wall edge of said rod base and the pivotal connect point of said actuating rod together with said side base so as to set said handle return to its normal not-locking position.

3. The locking device for a plane machine as claimed in claim 1, wherein said side bases respectively have its two sides provide with a limit groove extending in the moving direction of said actuating rod, a screw fitting in said limit groove and then screwing in said machines base so as to move limitedly therein.

4. The locking device for a plane machine as claimed in claim 1, wherein each said side base has its intermediate portion provided with a pivot stud upward, and said pivot studs respectively pivotally connected with two ends of said actuating rod lengthwise.

5. The locking device for a plane machine as claimed in claim 1, wherein one of said two urging blocks of each said side base is stationary, and the other is pivotally rotatable, said stationary urging block fixed firmly with a plate fixed at one side of said side base, said rotatable urging block pivotally connecting said urging block with the other side of said side base, a stop provided to rest on a side of said base and extends downward from the pivot point so as to limit said rotatable urging block to rotate inward, and a buffer spring fitted around said screw of said side base for inward rotation of said urging blocks and buffering the pressure of said urging blocks.

6. The locking device for a plane machine as claimed in claim 1, wherein each said urging block has its outer wall edge formed to have its front portion properly sloped to guide each said post to move smoothly into said urging surface of each said urging block.
